(19) United States
(12) Patent Application Publication
(10) Pub. No.: US 2011/0300867 A1
(43) Pub. Date: Dec. 8, 2011

(54) TERMINAL DEVICE, HOME BASE STATION, AND HOME BASE STATION SWITCHING DEVICE

(75) Inventors: Hidenori Matsuo, Kanagawa (JP); Takahisa Aoyama, Kanagawa (JP); Jun Hirano, Kanagawa (JP); Takashi Tamura, Kanagawa (JP); Chie Ishida, Kanagawa (JP)

(73) Assignee: PANASONIC CORPORATION, Osaka (JP)

(21) Appl. No.: 13/201,515

(22) PCT Filed: Feb. 16, 2010
(86) PCT No.: PCT/JP2010/000936

§ 371 Date: Aug. 15, 2011

(30) Foreign Application Priority Data
Feb. 24, 2009 (JP) 2009-041478

(51) Int. Cl. H04W 36/00

(52) U.S. Cl. 455/436

(57) ABSTRACT

A wireless communication system comprises an MME (70) which generates a white list in which CSG cells being accessible by a UE (10) are enumerated, an HeNB gateway (50) which decides based on the white list whether or not access is possible, and a home base station (30) (80) of the CSG cell. The UE (10) comprises a manual selection executing unit which accepts manual selection of a CSG cell, and requests the Mobility Management Entity to add the CSG cell to the white list; and a measurement report message generating unit which generates the Measurement report message attached with information indicating that the white list is being updated, if the CSG cell which has been accepted by manual selection is comprised in CSG cells to be included in the Measurement report message, and the selected CSG cell is not included in the white list stored in a white list storing unit. Thereby, there is provided a wireless communication system which can perform handover in which a manual selection process is appropriately reflected.

### RELATED APPLICATION

The present application claims the benefit of Japanese Patent Application No. 2009-041478, filed on Feb. 24, 2009, whose content is incorporated herein by reference.

### TECHNICAL FIELD

The present invention relates to a wireless communication system which performs handover to a CSG cell for which an access restriction can be imposed on a terminal device, and more particularly, to a wireless communication system which can perform manual selection of the CSG cell.

### BACKGROUND ART

[CSG (Closed Subscriber Group) Cell]

In 3GPP, it is considered that an indoor home base station (Home eNB: hereinafter referred to as “HeNB”) is installed to construct a CSG cell (3GPP TS36.300 Ver. 8.7.0). As shown in FIG. 24, the CSG cell is constructed in a cell (macro cell) constructed by a normal base station (eNB). The HeNB is different from the eNB and is provided with a function for enabling restriction of a terminal (User Equipment: hereinafter referred to as “UE”) which can access the HeNB, and the UE can connect only to the HeNB which the UE is permitted to access. Except in case of emergency, however good reception quality of an HeNB detected by the UE is, the UE cannot connect to the HeNB without the access permission.

In order for the UE to check the permission to access to the HeNB, the UE needs to check cell identification information (cell ID) included in broadcast information transmitted from the HeNB. As the cell ID, there are a Physical Cell ID (PCI) for locally identifying the eNB, a CSG ID for identifying the CSG cell, and the like. Hereinafter, “cell ID” is used to mean the latter CSG ID. The UE collates a cell ID list of accessible CSG cells (white list) which is notified from a network, with the cell ID received from the broadcast information, and if the cell ID of a detected CSG cell is included in the white list, the UE judges the detected CSG cell to be accessible.

High speed/high quality communication, low cost communication, services unique to the CSG cell, and the like can be realized by connecting to the CSG cell. It is conceivable that the UE hopes to connect to the CSG cell as much as possible if the UE has the access permission.

The HeNB connects to a gateway referred to as “HeNB gateway” (described as “HeNB GW” in the figure). In handover between the HeNBs under the control of the HeNB gateway, securing of network resources is terminated between the HeNB gateway and the HeNBs. It is conceivable that a process for deciding a final handover destination (Admission Control: hereinafter referred to as “Admission Control process”) is executed by the HeNB gateway. A Mobility Management Entity (hereinafter referred to as “MME”) is a terminal for an NAS message, such as a Tracking Area Update message, on the network side. Information on the white list is information on an individual UE. From a viewpoint of security, the HeNB assumed to be owned by each home does not have the information on the white list. On the other hand, the HeNB gateway and the MME can have the white list because the HeNB gateway and the MME are managed by operators.

[Handover Among CSG Cells]

FIG. 25 is a diagram showing a handover process. In order to perform the handover among the CSG cells, the UE first measures reception quality of signals from neighboring base stations (Measurement). Next, the UE detects a base station having good reception quality, and notifies a base station being currently connected (source HeNB) of a result of the detection by using a Measurement report message. The source HeNB, which has received the Measurement report message, notifies the HeNB gateway of information required for performing the handover and information on a cell which is a handover destination (target cell). A Handover preparation message (hereinafter referred to as “HO preparation”) is used for the notification here.

The HeNB gateway checks whether or not the UE is permitted to access the target cell notified in the HO preparation, with reference to the white list. If the UE has the access permission, the HeNB gateway notifies the target cell of setting information required for the handover. The HO preparation is used for the notification here. The HeNB gateway notifies the UE of the setting information required for performing the handover, through the source HeNB. An HO preparation response message is used from the HeNB gateway to the source HeNB, and an HO execution command is used from the source HeNB to the UE.

### SUMMARY OF INVENTION

### Technical Problem

In 3GPP, manual selection is considered in which a user manually selects a desired CSG cell. Here, the manual selection will be described. In the manual selection, first, the UE searches for neighboring CSG cells. The UE displays a result of the search on a display so that the user can check the search result. When the user selects a CSG cell desired to be connected, from a list of the CSG cells displayed on the display, the white list is updated, and access to the CSG cell which has not been in the white list until then is enabled. However, the update of the white list through the manual selection and the handover are independently executed, respectively, and thus the handover to the cell desired by the user through the manual selection is highly likely to be impossible.

In view of the above described background, an object of the present invention is to provide a wireless communication system and a CSG handover method which can perform handover in which a manual selection process is appropriately reflected.

### Solution to Problem

A wireless communication system of the present invention comprises a Mobility Management Entity which generates a white list in which CSG cells being accessible by a terminal device are enumerated, a HeNB gateway which decides based on the white list whether or not access is possible, a home base station of the CSG cell, and the terminal device.

The terminal device comprises a white list storing unit which has stored the white list; a manual selection executing unit which accepts manual selection of a CSG cell, and if the selected CSG cell has not been stored in the white list storing unit, requests the Mobility Management Entity to add the CSG cell to the white list; a measurement report message generating unit which measures radio wave reception quality of neighboring CSG cells and generates a Measurement report message, the measurement report message generating unit generating the Measurement report message attached with information indicating that the white list is being updated, if the CSG cell which has been accepted by manual selection is comprised in CSG cells to be included in the Measurement report message, and the selected CSG cell has not been stored in the white list storing unit; and a measurement report message transmitting unit which transmits the Measurement report message to a home base station of the CSG cell.

The home base station comprises a measurement report message receiving unit which receives a Measurement report message transmitted from the terminal device; a detecting unit which detects whether or not information indicating that the white list is being updated is included in the Measurement report message; a generating unit which generates a Handover preparation message in response to the Measurement report message, the generating unit generating the Handover preparation message including the information indicating that the white list is being updated, when the information indicating that the white list is being updated has been detected; and a transmitting unit which transmits the Handover preparation message to the HeNB gateway.

The HeNB gateway comprises a receiving unit which receives a Handover preparation message transmitted from a home base station of the CSG cell; a detecting unit which detects whether or not information indicating that the white list is being updated is included in the Handover preparation message; and a deciding unit which decides a handover destination when the Handover preparation message has been received, the deciding unit waiting for reception of a white list update response from the Mobility Management Entity and then deciding the handover destination, when the information indicating that the white list is being updated has been detected.

In this way, when the terminal device transmits the Measurement report message after the CSG cell has been added to the white list through the manual selection, the terminal device attaches the information indicating that the white list is being updated, to the Measurement report message. Since a request for updating the white list is transmitted to the Mobility Management Entity, for example, with an NAS message, the HeNB gateway cannot recognize that the white list is being updated. However, according to a configuration of the present invention, the HeNB gateway can recognize that the white list is being updated.

If the information indicating that the white list is being updated is included in the Measurement report message, the HeNB gateway waits for the reception of the white list update response from the Mobility Management Entity and then decides the handover destination. Thus, the HeNB gateway can decide the handover destination based on the white list to which the manually selected CSG cell has been added.

### Advantageous Effects of Invention

According to the present invention, the terminal device transmits the Measurement report message including the information indicating that the white list is being updated, and thus, there is an excellent advantageous effect that the HeNB gateway can decide the handover destination based on the updated white list, and can appropriately select the handover destination, even if a request for manually updating the white list and the Measurement report message contend with each other.

As described below, there are other aspects of the present invention. Accordingly, in the disclosure of the present invention, it is intended to provide a part of the present invention, and it is not intended to limit the scope of the invention described and claimed herein.

### BRIEF DESCRIPTION OF DRAWINGS

FIG. 1 is a diagram showing an outline of a processing procedure of handover in a wireless communication system of a first embodiment.

FIG. 2 is a diagram showing a configuration of a UE of the first embodiment.

FIG. 3 is a diagram showing a configuration of a source HeNB of the first embodiment.

FIG. 4 is a diagram showing a configuration of an HeNB gateway of the first embodiment.

FIG. 5 is a diagram showing operations of respective Entities in the handover of the first embodiment.

FIG. 6 is a diagram showing the operations of the respective Entities in the handover of the first embodiment.

FIG. 7 is a diagram showing the operations of the respective Entities in the handover of the first embodiment.

FIG. 8 is a diagram showing the operations of the respective Entities in the handover of the first embodiment.

FIG. 9 is a diagram showing a configuration of an MME of a second embodiment.

FIG. 10 is a diagram showing the configuration of the HeNB gateway of the second embodiment.

FIG. 11 is a diagram showing operations for the handover of the second embodiment.

FIG. 12 is a diagram showing the operations for the handover of the second embodiment.

FIG. 13 is a diagram showing the configuration of the HeNB gateway of a third embodiment.

FIG. 14 is a diagram showing the operations for the handover of the third embodiment.

FIG. 15 is a diagram showing the operations for the handover of the third embodiment.

FIG. 16 is a diagram showing the configuration of the UE of a fourth embodiment.

FIG. 17 is a diagram showing a Measurement report message before a cell list is modified.

FIG. 18 is a diagram showing the Measurement report message after the cell list is modified.

FIG. 19 is a diagram showing the operations for the handover of the fourth embodiment.

FIG. 20 is a diagram showing the configuration of the source HeNB of a fifth embodiment.

FIG. 21 is a diagram showing the configuration of the HeNB gateway of the fifth embodiment.

FIG. 22 is a diagram showing the operations for the handover of the fifth embodiment.

FIG. 23 is a diagram showing the operations for the handover of the fifth embodiment.

FIG. 24 is a diagram showing an architecture configuration of a CSG cell system.

FIG. 25 is a diagram showing a processing procedure of handover among CSG cells.

### DESCRIPTION OF EMBODIMENTS

Hereinafter, the present invention will be described in detail. Embodiments to be described below are merely examples of the present invention, and the present invention can be varied in various aspects. Accordingly, particular configurations and functions to be disclosed below do not limit the claims.

Hereinafter, a handover method of the embodiments of the present invention will be described with reference to the drawings.

### First Embodiment

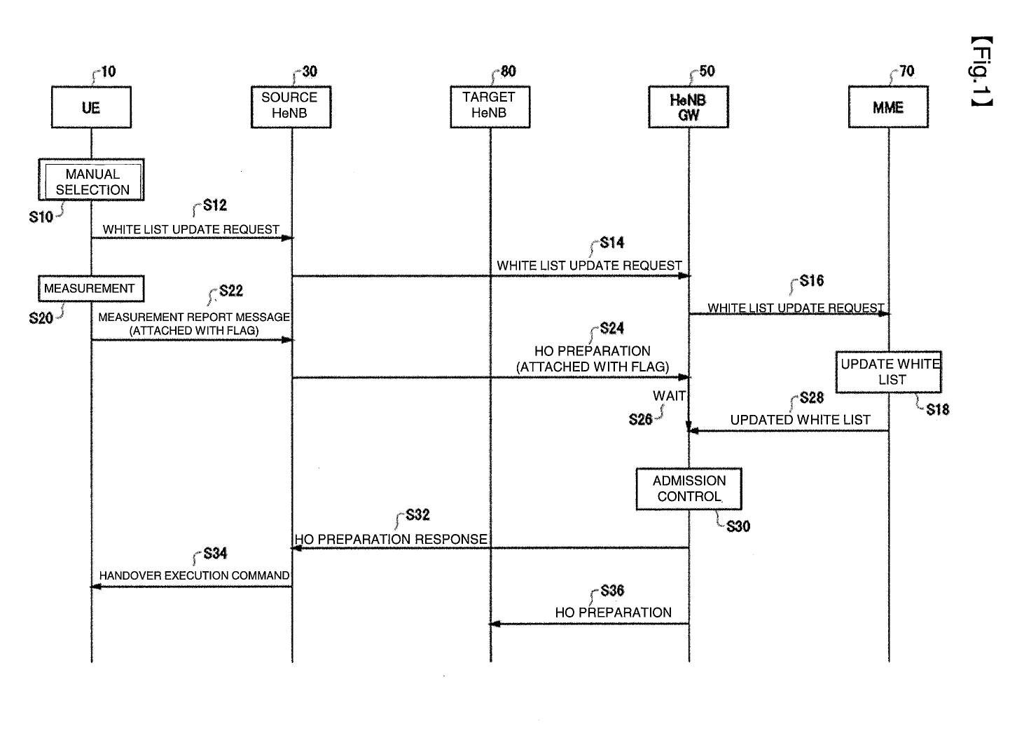

FIG. 1 is a flowchart showing a summary of the handover method of a first embodiment. First, the summary will be described with reference to FIG. 1. In the present embodiment, a UE 10 notifies respective Entities on a network side of information indicating that a white list is being updated through manual selection, and thereby, the respective Entities cooperate with one another to execute the handover process.

If a CSG cell selected by a user through a manual selection process (S10) is not included in the white list, the UE 10 executes a Manual update process for adding the CSG cell selected by the user to the white list. Specifically, the UE 10 transmits a Tracking Area Update message (this is referred to as “white list update request”) including a cell ID of the CSG cell selected by the user, to an MME 70 via a source HeNB 30 and an HeNB gateway 50 (S12, S14 and S16). When receiving the Tracking Area Update message, the MME 70 adds the cell ID of the user's desired CSG cell which is included in the white list update request, to the white list (S18).

While the white list is being updated, the UE 10 measures reception quality of adjacent base stations (S20), and when the UE 10 transmits a Measurement report message to the source HeNB 30, the UE 10 inserts a flag indicating that the white list is currently being updated (white list update flag) into the Measurement report message (S22). When receiving the Measurement report message, the source HeNB 30 transmits HO preparation including handover setting information to the HeNB gateway 50 (S24). When detecting a Manual update flag from the Measurement report message, the source HeNB 30 judges that the white list is being updated, and inserts the Manual update flag into the HO preparation (S24).

When the HeNB gateway 50 detects the Manual update flag in the HO preparation received from the source HeNB 30, the HeNB gateway 50 judges that the white list is currently being updated. The HeNB gateway 50 delays an Admission Control process for deciding a target cell which becomes a handover destination, until the HeNB gateway 50 receives the white list updated through the Manual update, from the MME 70 (S26).

When receiving the updated white list (S28), the HeNB gateway 50 executes the Admission Control process to decide the target cell (S30). A subsequent process is similar to a normal handover processing procedure. Specifically, the HeNB gateway 50 transmits an HO preparation response to the source HeNB 30 (S32), and the source HeNB 30 which receives this HO preparation response transmits a handover execution command to the UE 10 (S34). Next, the HeNB gateway 50 transmits the HO preparation to a target HeNB 80 (S36). Thereby, the UE 10 can perform the handover to the user's desired CSG cell which has been selected through the manual selection.

On the other hand, if the CSG cell selected by the user through the manual selection process has already been included in the white list, or if the CSG cell selected by the user is not included in the Measurement report message transmitted from the UE 10 to the source HeNB 30, the UE 10 executes a normal handover process.

Next, respective Entities constituting a wireless communication system of the present embodiment will be described.

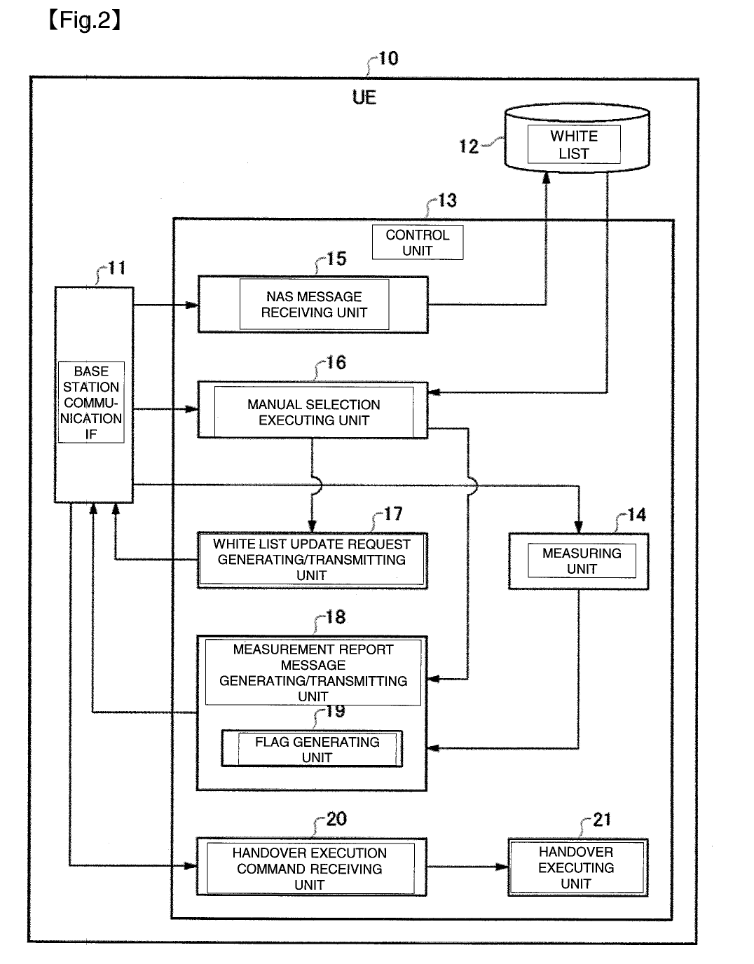

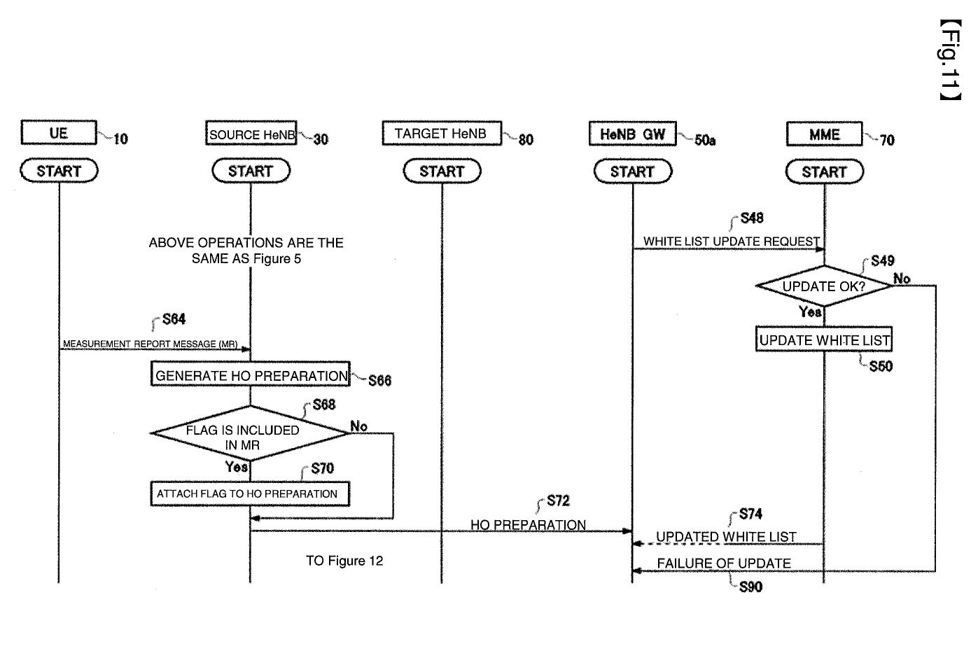

FIG. 2 is a diagram showing a configuration of the UE 10. The UE 10 has a base station communication interface (described as “base station communication IF” in the FIG. 11 which performs communication with a base station, a white list storing unit 12 which has stored information on the CSG cell which the UE 10 is permitted to access (that is, the white list), and a control unit 13 which performs various controls of the UE 10.

The control unit 13 has a measuring unit 14, an NAS message receiving unit 15, a manual selection executing unit 16, a white list update request generating/transmitting unit 17, a measurement report message generating/transmitting unit 18, a handover execution command receiving unit 20, and a handover executing unit 21.

The NAS message receiving unit 15 receives information on the updated white list transmitted as an NAS message, and stores the information on the updated white list in the white list storing unit 12. The measuring unit 14 measures the quality of received signal from the base station. The measurement report message generating/transmitting unit 18 generates the Measurement report message based on a result of the measurement, and transmits the Measurement report message to the source HeNB 30. In the present embodiment, the measurement report message generating/transmitting unit 18 generates the flag indicating that the white list is being updated, in a flag generating unit 19, while the manual selection is being executed, and attaches the flag to a measurement report. Here, since the flag only needs to indicate whether or not the white list is being updated, an amount of information may be one bit. The HeNB gateway 50 can be notified that the white list is being updated, only by inserting the one-bit flag into an existing message.

The manual selection executing unit 16 displays neighboring CSG cells on a display to cause the user to select the desired CSG cell, and if the selected CSG cell is not in the white list, the manual selection executing unit 16 notifies the white list update request generating/transmitting unit 17 of nonexistence of the selected CSG cell in the white list. The white list update request generating/transmitting unit 17 generates the white list update request by including the cell ID of the CSG cell selected by the user into the Tracking Area Update message, and transmits the white list update request to the MME 70.

The handover execution command receiving unit 20 receives the handover execution command, and notifies the handover executing unit 21 of the handover execution command. The handover executing unit 21 executes the handover.

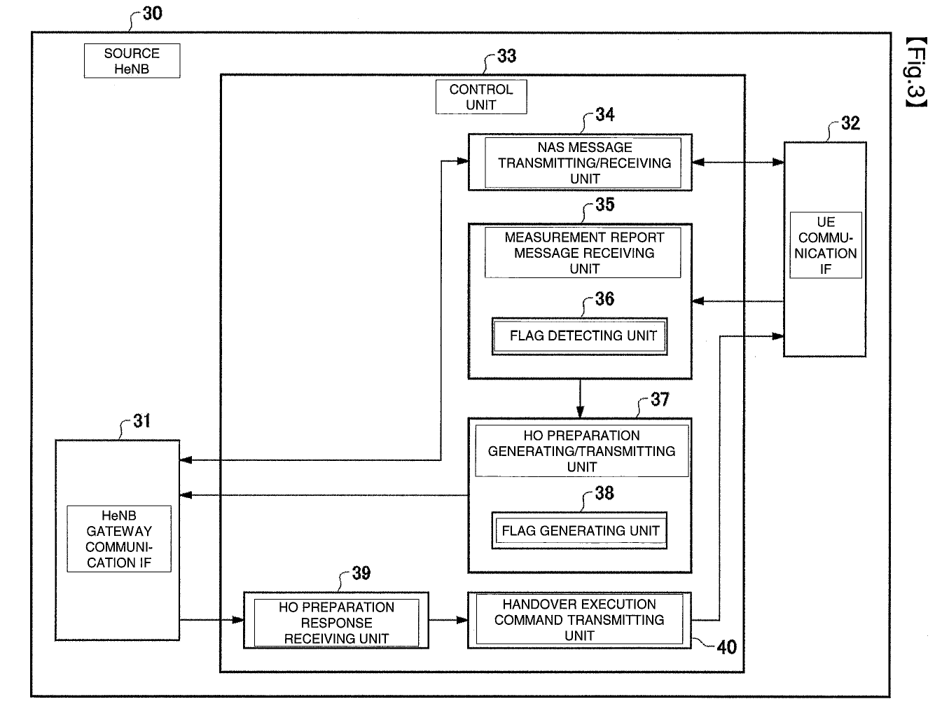

FIG. 3 is a diagram showing a configuration of the source HeNB 30. The source HeNB 30 has a HeNB gateway communication interface (described as “HeNB gateway communication IF” in the FIG. 31 which performs communication with the HeNB gateway 50, a UE communication interface (described as “UE communication IF” in the FIG. 32 which performs communication with the UE 10, and a control unit 33 which controls the source HeNB 30.

The control unit 33 has an NAS message transmitting/receiving unit 34, a measurement report message receiving unit 35, a handover preparation generating/transmitting unit (hereinafter referred to as “HO preparation generating/transmitting unit”) 37, an HO preparation response receiving unit 39, and a handover execution command transmitting unit 40. The NAS message transmitting/receiving unit 34 transmits and receives the white list update request and the updated white list as the NAS messages.

When receiving the Measurement report message from the UE 10, the measurement report message receiving unit 35 notifies the HO preparation generating/transmitting unit 37 of the reception of the Measurement report message. The HO preparation generating/transmitting unit 37 generates the HO preparation, and transmits the HO preparation to the HeNB gateway 50. The measurement report message receiving unit 35 of the present embodiment detects in a flag detecting unit 36 whether or not the white list update flag is in the Measurement report message. If the flag detecting unit 36 detects the flag, the flag detecting unit 36 passes information on the flag to the HO preparation generating/transmitting unit 37. If the HO preparation generating/transmitting unit 37 receives the information on the flag, the HO preparation generating/transmitting unit 37 generates the HO preparation attached with the information on the flag.

The HO preparation response receiving unit 39 receives a response indicating whether or not the handover is possible, from the HeNB gateway 50, and passes the received information to the handover execution command transmitting unit 40. If the handover is possible, the handover execution command transmitting unit 40 transmits the handover execution command to the UE 10.

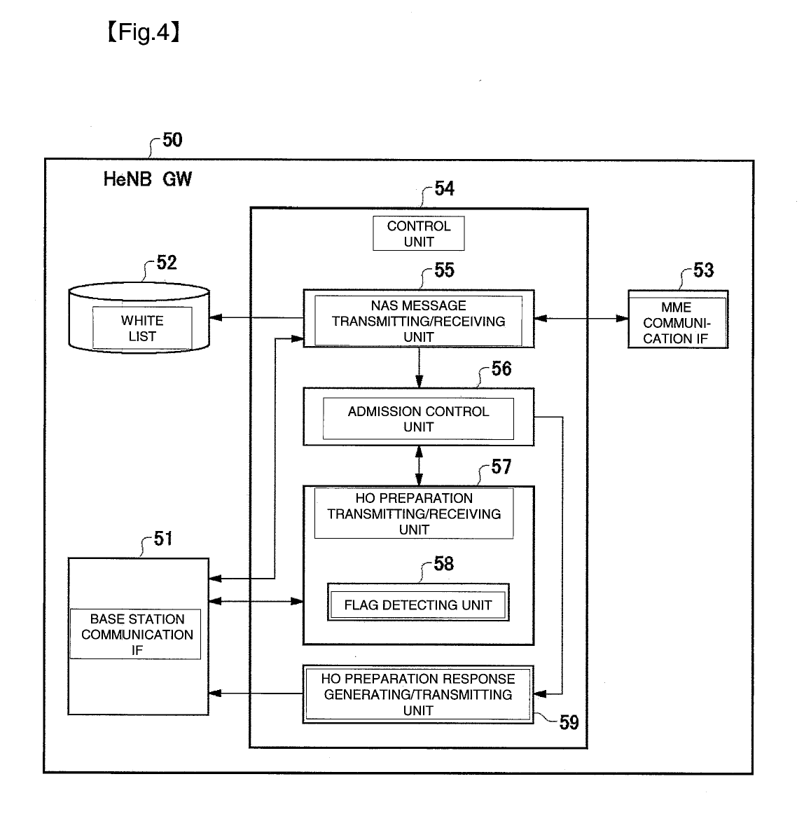

FIG. 4 is a diagram showing a configuration of the HeNB gateway (described as “HeNB GW” in the figure) 50. The HeNB gateway 50 has a base station communication interface (described as “base station communication IF” in the figure) 51 which performs communication with the HeNB, a white list storing unit 52 which stores the white list, an MME communication interface (described as “MME communication IF” in the figure) 53 which performs communication with the MME 70, and a control unit 54 which controls the HeNB gateway 50.

The control unit 54 has an NAS message transmitting/receiving unit 55, an Admission Control unit 56, an HO preparation transmitting/receiving unit 57, and an HO preparation response generating/transmitting unit 59. The NAS message transmitting/receiving unit 55 transmits and receives the white list update request and the updated white list as the NAS messages.

The HO preparation transmitting/receiving unit 57 receives the HO preparation transmitted from the source HeNB 30, and passes received information to the Admission Control unit 56. The HO preparation transmitting/receiving unit 57 has a flag detecting unit 58. The flag detecting unit 58 detects whether or not the flag indicating that the white list is being updated is included in the HO preparation. If the flag indicating that the white list is being updated is included, the HO preparation transmitting/receiving unit 57 notifies the Admission Control unit 56 that the flag indicating that the white list is being updated has been included.

The Admission Control unit 56 performs the Admission Control process to decide whether or not the handover to the target HeNB is possible. When the handover to the target HeNB is impossible, the Admission Control unit 56 decides another cell as the handover destination. If the flag indicating that the white list is being updated has been received, the Admission Control unit 56 waits for the updated white list to be transmitted from the MME 70, and then performs the Admission Control process.

The HO preparation response generating/transmitting unit 59 generates the HO preparation response, and transmits the HO preparation response to the source HeNB 30.

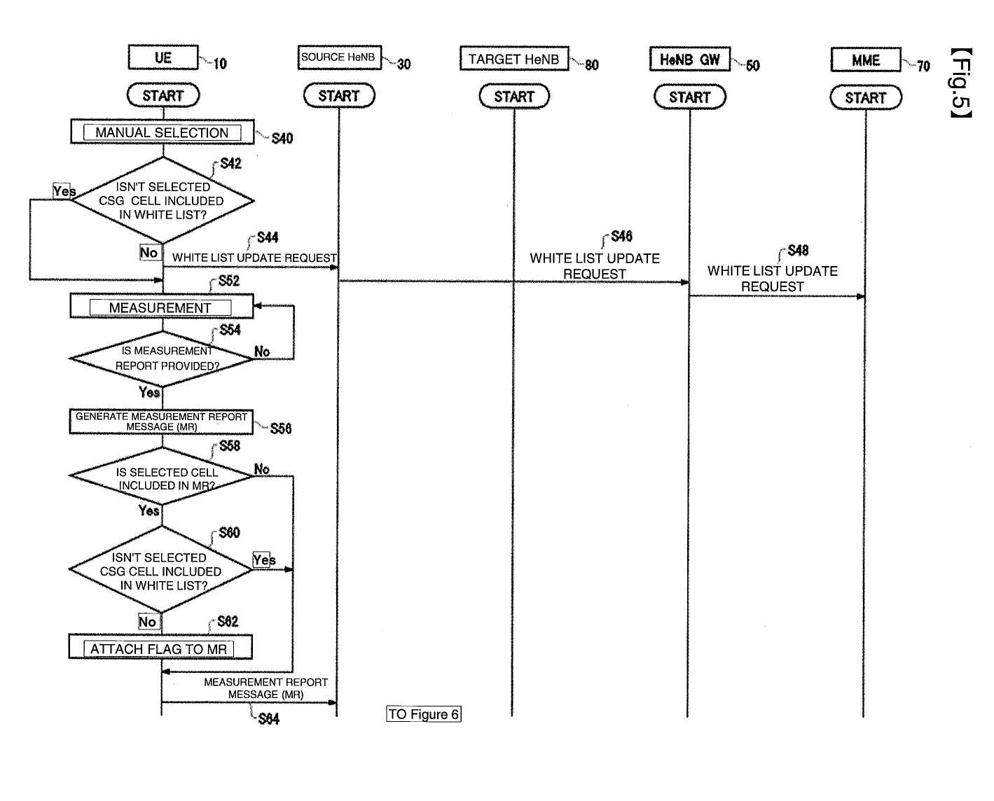

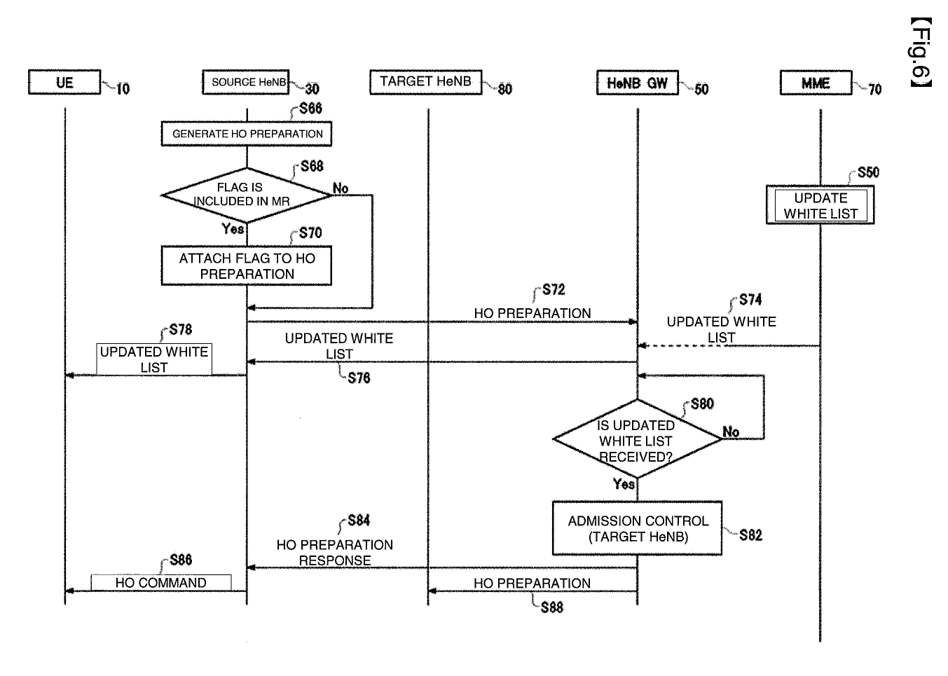

FIGS. 5 and 6 are diagrams showing operations of the respective Entities of the wireless communication system of the first embodiment in detail. When the user performs the manual selection (S40), the UE 10 determines whether the selected CSG cell is not included in the white list (S42). Specifically, the UE 10 reads the white list stored in the white list storing unit 12, and checks whether or not the cell ID of the selected CSG cell is included.

If the selected CSG cell is not included in the white list (No in S42), the UE 10 transmits the white list update request to the source HeNB 30 (S44). The source HeNB 30 transmits the white list update request to the HeNB gateway 50 (S46), and the HeNB gateway 50 transmits the received white list update request to the MME 70 (S48). When receiving the white list update request, the MME 70 performs a white list update process (S50).

The UE 10 measures the quality of received signal from neighboring HeNBs (S52), and determines whether or not to transmit the Measurement report message (S54). If the UE 10 transmits the Measurement report message (Yes in S54), the UE 10 generates the Measurement report message (S56). The UE 10 determines whether or not the CSG cell selected in the manual selection is included in the Measurement report message (S58). If it is determined that the selected CSG cell is included (Yes in S58), the UE 10 determines whether the selected CSG cell is not included in the white list (S60). If it is determined that the selected CSG cell is not included (No in S60), the UE 10 attaches the flag indicating that the white list is being updated, to the Measurement report message (S62). The UE 10 transmits the Measurement report message to the source HeNB 30 (S64).

When receiving the measurement report, the source HeNB 30 generates the HO preparation (S66). The source HeNB 30 determines whether or not the white list updating flag is included in the Measurement report message (S68). If the white list updating flag is included (Yes in S68), the source HeNB 30 attaches the white list updating flag to the HO preparation (S70). The source HeNB 30 transmits the HO preparation to the HeNB gateway 50 (S72). FIGS. 5 and 6 show an example in which the source HeNB 30 has transmitted the HO preparation attached with the white list updating flag.

When receiving the HO preparation and detecting that the white list updating flag is included in the HO preparation, the HeNB gateway 50 does not immediately perform the Admission Control process, and waits for the updated white list to be transmitted from the MME 70.

When the updated white list is transmitted from the MME 70 (S74), the HeNB gateway 50 transmits the information on the updated white list to the source HeNB 30 with the NAS message (S76), and the source HeNB 30 transfers the NAS message to the UE 10 (S78).

The HeNB gateway 50 determines whether or not the HeNB gateway 50 has received the updated white list (S80), and when receiving the white list (Yes in S80), the HeNB gateway 50 updates the white list in the white list storing unit 52, and then performs the Admission Control process for determining whether or not the handover to the target cell is possible (S82). The HeNB gateway 50 transmits the HO preparation response to the source HeNB 30 (S84), and also transmits the HO preparation to the target HeNB 80 (S88). The source HeNB 30 transmits the handover execution command to the UE 10 (S86).

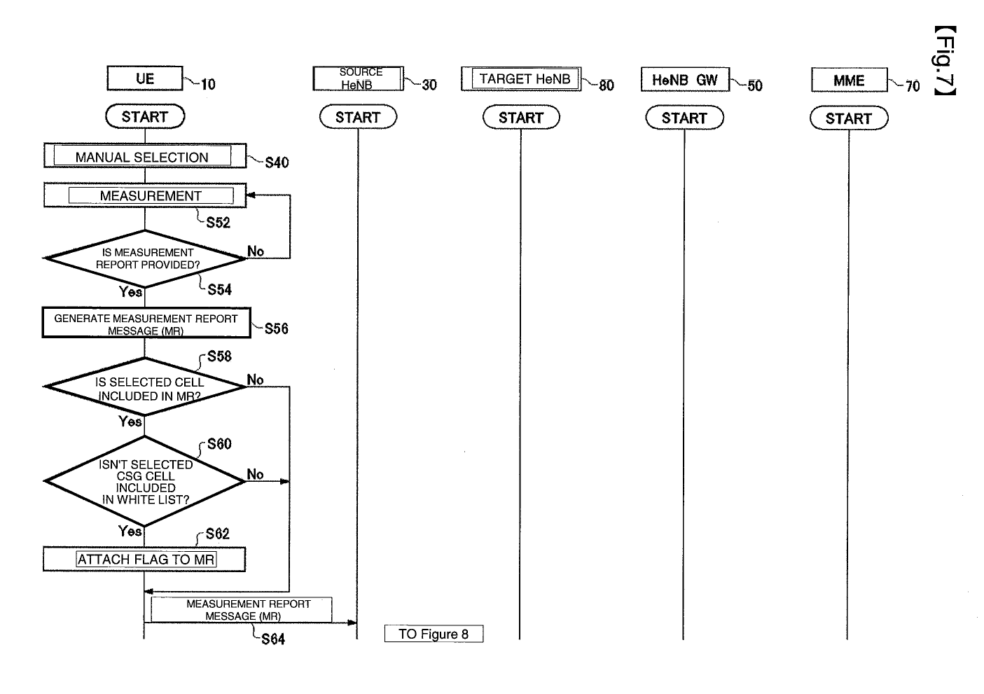

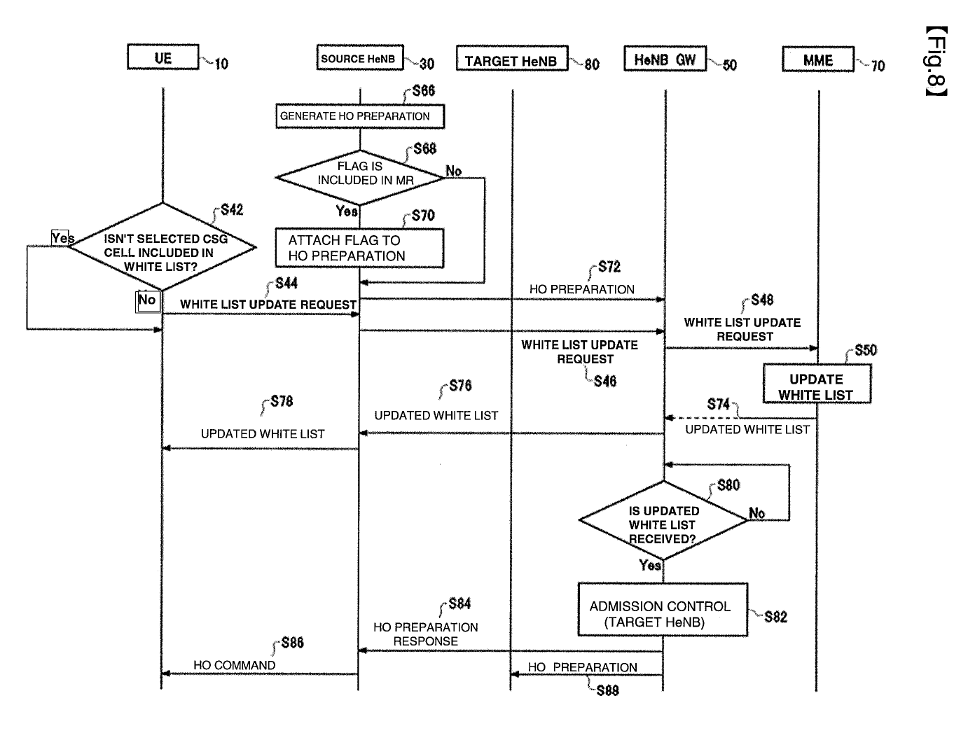

FIGS. 7 and 8 are diagrams showing other operations of the respective Entities of the wireless communication system of the first embodiment in detail. The operations of the wireless communication system shown in FIGS. 7 and 8 are basically the same as the operations of the wireless communication system shown in FIGS. 5 and 6. FIGS. 7 and 8 show an example in which the Measurement report message is transmitted (S52 to S64) after the manual selection is performed (S40) until the white list update request is transmitted (S44). Depending on a timing of performing the measurement of the reception quality, the Measurement report message is transmitted before the white list update request is transmitted. However, in this way, even before the white list update request is transmitted, if the manual selection has been performed, the white list updating flag is attached to the Measurement report message. Hereinabove, the wireless communication system and the handover method of the first embodiment have been described.

In the wireless communication system of the first embodiment, if the Measurement report message including the selected CSG cell is transmitted after the manual selection has been performed, the flag indicating that the white list is being updated is attached to the Measurement report message, and the HeNB gateway 50 is notified that the white list is being updated. If the updating flag is included in the Measurement report message, the HeNB gateway 50 waits for the updated white list to be transmitted from the MME 70, and then performs the Admission Control process. Thereby, it is possible to prevent inconvenience that the handover to the CSG cell selected by the user is determined to be impossible because the Admission Control process is performed before the addition to the white list is completed, and the handover to the CSG cell selected in the manual selection can be performed.

### Second Embodiment

Next, the wireless communication system of a second embodiment will be described. In the first embodiment, a processing procedure has been described in a case where the MME 70 has successfully updated the white list, that is, in a case where the cell ID of the user's desired CSG cell has been able to be added to the white list. In the second embodiment, the wireless communication system which appropriately operates even if the MME 70 has not permitted the update of the white list will be described. In the second embodiment, the configurations of the UE and the source HeNB are the same as the first embodiment.

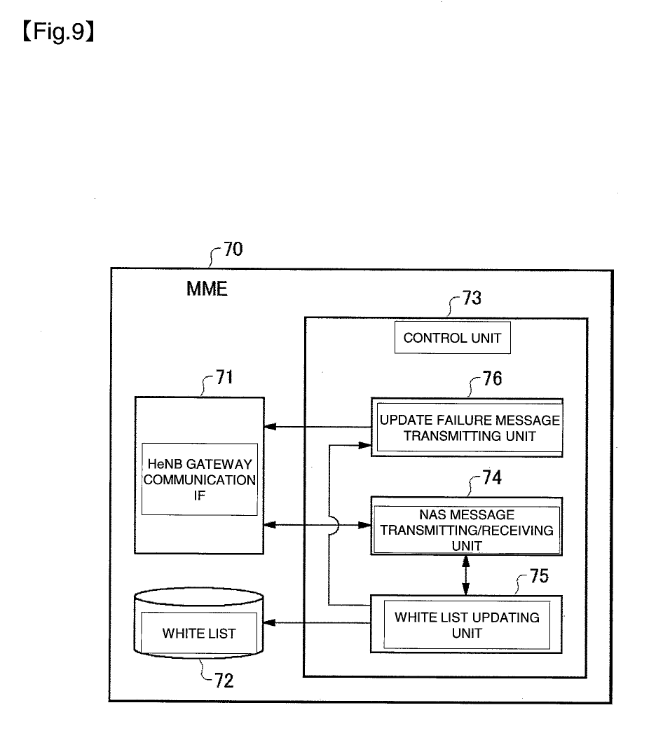

FIG. 9 is a diagram showing a configuration of the MME 70 in the second embodiment. The MME 70 has an HeNB gateway communication interface (described as “HeNB gateway communication IF” in the FIG. 71 for communicating with the HeNB gateway 50, a white list storing unit 72 which has stored the white list, and a control unit 73 which controls the MME 70.

The control unit 73 has an NAS message transmitting/receiving unit 74, a white list updating unit 75, and an update failure message transmitting unit 76. The NAS message transmitting/receiving unit 74 transmits and receives a white list update message and the updated white list as the NAS messages. The white list updating unit 75 updates the white list stored in the white list storing unit 72. The update failure message transmitting unit 76 transmits an update failure message to the HeNB gateway 50 when the update of the white list has been failed in the white list updating unit 75.

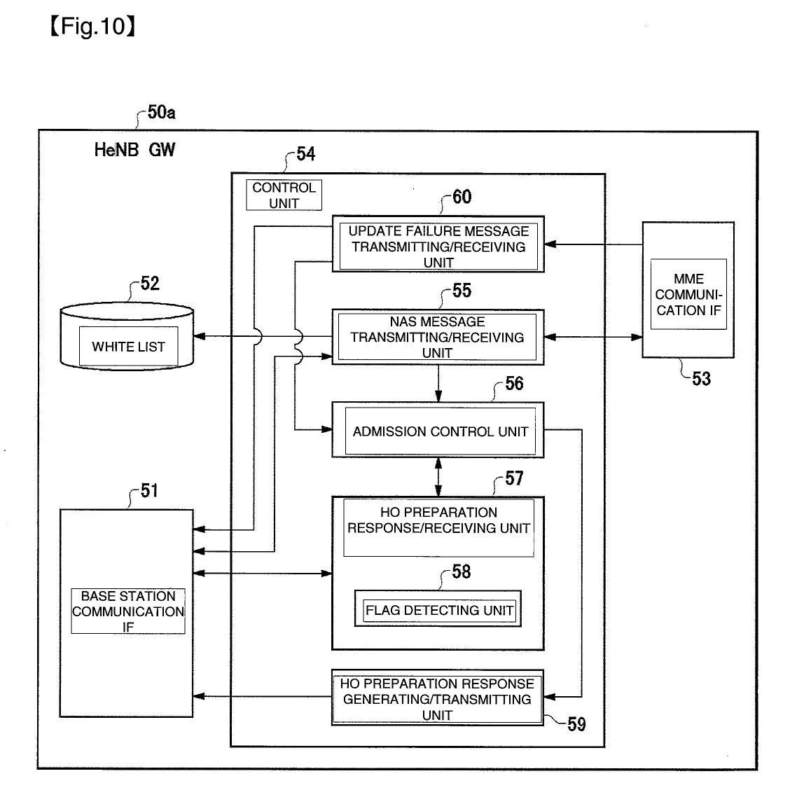

FIG. 10 is a diagram showing a configuration of an HeNB gateway 50a in the second embodiment. In addition to the configuration of the HeNB gateway 50 of the first embodiment, the HeNB gateway 50a of the second embodiment has an update failure message transmitting/receiving unit 60 which transmits and receives the update failure message. The update failure message transmitting/receiving unit 60 receives the update failure message transmitted from the MME 70.

When receiving the update failure message, the update failure message transmitting/receiving unit 60 notifies the Admission Control unit 56 of the reception of the update failure message. When receiving the update failure message, the Admission Control unit 56 decides the handover destination based on the white list stored in the white list storing unit 52. Moreover, the update failure message transmitting/receiving unit 60 transmits the update failure message to the source HeNB 30.

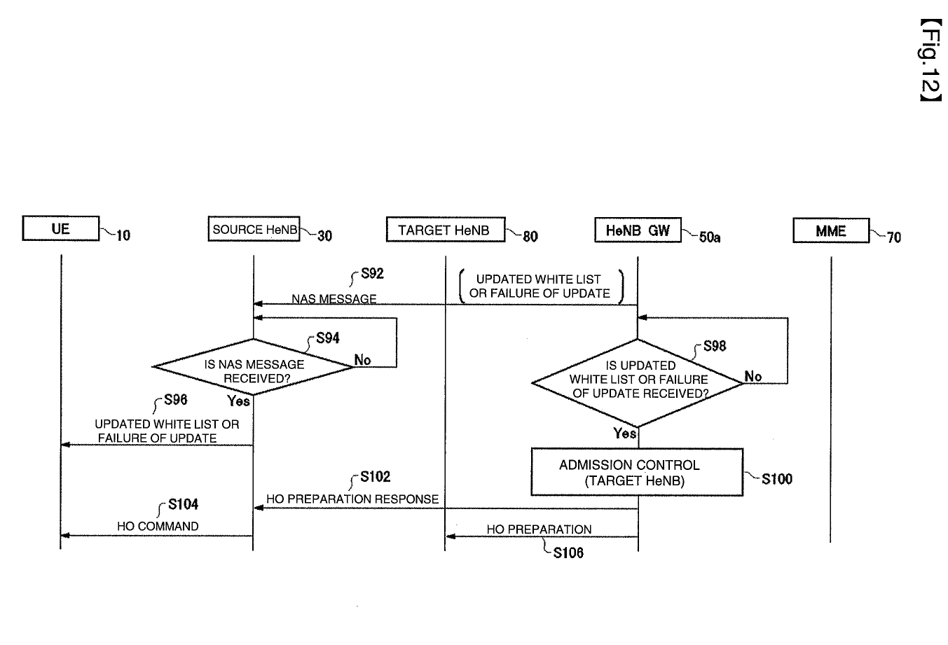

FIGS. 11 and 12 are diagrams showing the operations for the handover by the wireless communication system of the second embodiment. Basic operations for the handover of the second embodiment are the same as the operations for the handover of the first embodiment. However, the operations for the handover of the second embodiment are different in that an operation performed when the update of the white list has been failed in the MME 70 is added. Hereinafter, an added process will be described.

When receiving the white list update request (S48), the MME 70 determines whether or not the white list can be updated (S49). If it is determined that the white list cannot be updated (No in S49), the MME 70 transmits the update failure message to the HeNB gateway 50 (S90). According to the message received from the MME 70, the HeNB gateway 50 transmits the updated white list or the failure of the update, to the source HeNB 30 with the NAS message (S92). The source HeNB 30 determines whether or not the NAS message has been received (S94), and if it is determined that the NAS message has been received (Yes in S94), the source HeNB 30 transmits the updated white list or the failure of the update to the UE 10 (S96).

The HeNB gateway 50 determines whether or not the updated white list or the update failure message has been received (S98). If it is determined that the updated white list or the update failure message has been received (Yes in S98), the HeNB gateway 50 performs the Admission Control process (S100).

It should be noted that, in a case of the failure of the update, the HeNB gateway 50 performs the Admission Control process without updating the white list in the white list storing unit 52. In this case, the handover to the CSG cell selected through the manual selection is not permitted, and another cell is decided as the handover destination.

The HeNB gateway 50 transmits the HO preparation response to the source HeNB 30 (S102), and transmits the HO preparation to the handover destination decided based on the Admission Control process (S106). Hereinabove, the configuration and the operations of the wireless communication system of the second embodiment have been described.

In the wireless communication system of the second embodiment, when the MME 70 has failed to update the white list, the HeNB gateway 50 receives the update failure message from the MME 70 (S90). Thus, this message can be used as a trigger to start the Admission Control process (S100). Accordingly, even if the MME 70 has failed to update the white list, inconvenience that the Admission Control process is not started forever does not occur, and an appropriate handover process can be performed.

### Third Embodiment

Next, the wireless communication system of a third embodiment will be described. In the second embodiment, a processing procedure has been described in which the Admission Control process is executed if the updated white list or the update failure message has been received from the MME 70. In the third embodiment, the wireless communication system which appropriately operates even if the HeNB gateway 50a is not notified of a result of the update of the white list, from the MME 70, will be described. In the third embodiment, the configurations of the UE, the MME and the source HeNB are the same as the second embodiment.

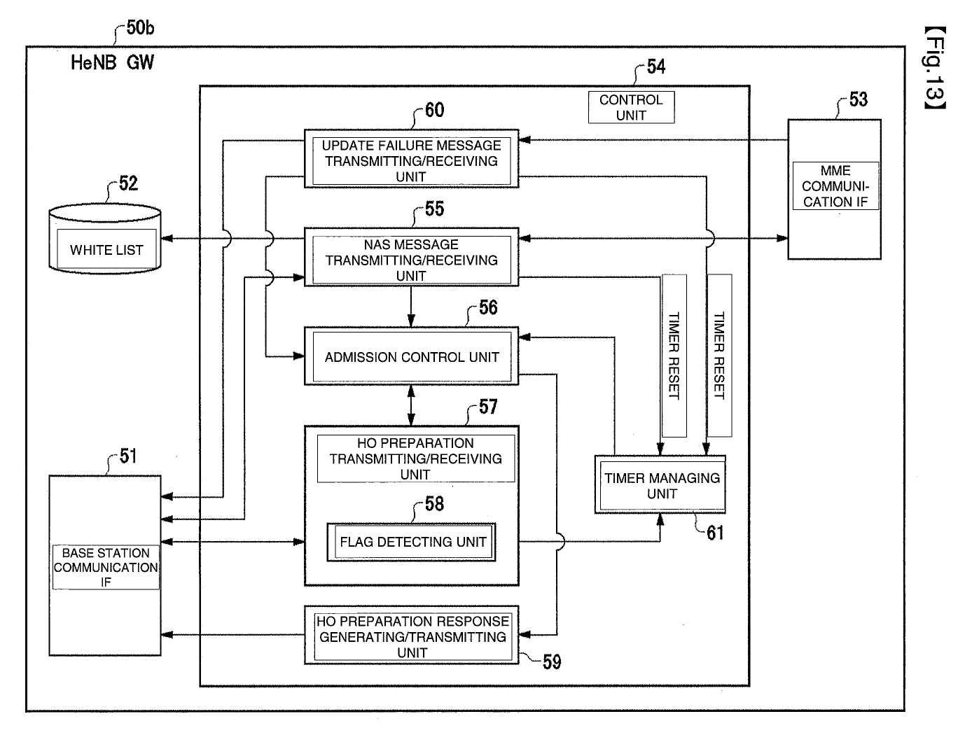

FIG. 13 is a diagram showing a configuration of an HeNB gateway 50b of the third embodiment. In addition to the configuration of the HeNB gateway 50a of the second embodiment, the HeNB gateway 50b of the third embodiment has a timer managing unit 61. The timer managing unit 61 starts a timer when the HO preparation transmitting/receiving unit 57 has received the HO preparation from the source HeNB 30, and measures a time elapsed since the reception of the HO preparation. If the NAS message transmitting/receiving unit 55 has received the updated white list, or if the update failure message transmitting/receiving unit 60 has received the update failure message, the timer managing unit 61 resets the timer. If the timer has exceeded a predetermined set time, or if the timer has expired, the timer managing unit 61 notifies the Admission Control unit 56 of the expiration of the timer, and the Admission Control unit 56 executes the Admission Control process.

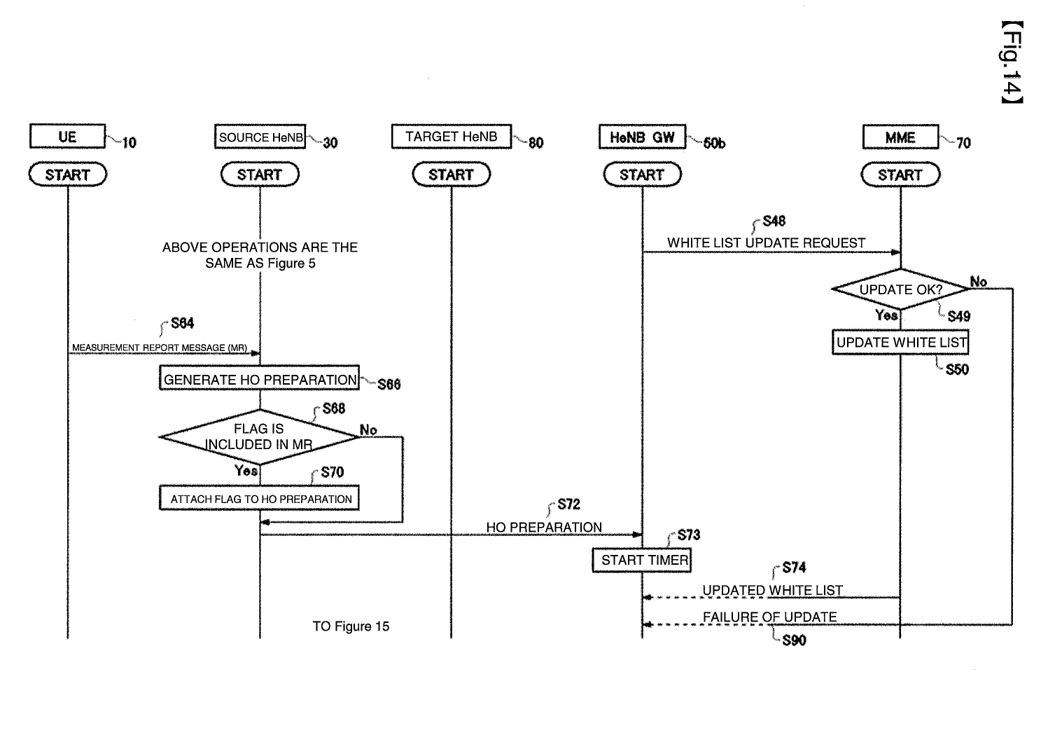

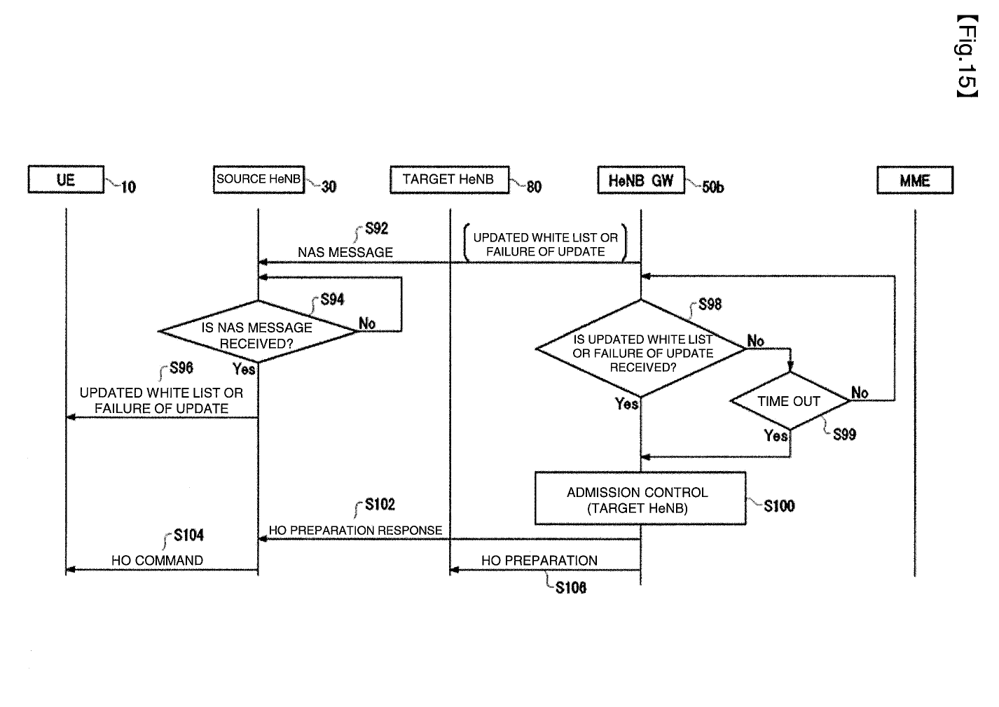

FIGS. 14 and 15 are diagrams showing the operations for the handover by the wireless communication system of the third embodiment. The basic operations for the handover of the third embodiment are the same as the operations for the handover of the second embodiment. However, the operations for the handover of the third embodiment are different in that an operation in a case where there has been no response to the update of the white list from the MME 70 is added. Hereinafter, an added process will be described.

When receiving the HO preparation from the source HeNB 30 (S72), the HeNB gateway 50 starts the timer in the timer managing unit 61 (S73). The HeNB gateway 50 determines whether or not the updated white list or the update failure message has been received (S98), and if neither has been received (No in S98), the HeNB gateway 50 determines whether or not the timer has timed out (S99).

If it is determined that the timer has timed out (Yes in S99), the HeNB gateway 50 starts the Admission Control process (S100). If it is determined that the timer has not timed out (No in S99), the HeNB gateway 50 determines again whether or not the updated white list or the failure of the update has been received (S98). In other words, the HeNB gateway 50 repeatedly determines whether or not the updated white list or the failure of the update has been received, until the timer times out. Hereinabove, the configuration and the operations of the wireless communication system of the third embodiment have been described.

In the third embodiment, when receiving the HO preparation (S72), the HeNB gateway 50 does not perform the Admission Control process and waits until the updated white list or the update failure message is transmitted from the MME 70. However, if the updated white list or the update failure message is not received even after a predetermined time has elapsed since the reception of the HO preparation, the HeNB gateway 50 performs the Admission Control process (S100). Accordingly, if the notification from the MME 70 cannot be received for some reason, the appropriate handover process can be performed without continuing to wait for the notification from the MME 70.

### Fourth Embodiment

Next, the wireless communication system of a fourth embodiment will be described. Usually, as a candidate for the target cell which becomes the handover destination to be put into the HO preparation, a cell having best reception quality is selected from the cells included in the Measurement report message received from the UE 10 by the source HeNB 30. If the reception quality of the CSG cell selected through the manual selection is not the best, the selected cell does not become the candidate for the target cell in the HO preparation. Thus, even if the Manual update is executed, the handover to the user's desired cell cannot be performed. In the present embodiment, a method of performing the handover to the CSG cell selected through the manual selection will be shown.

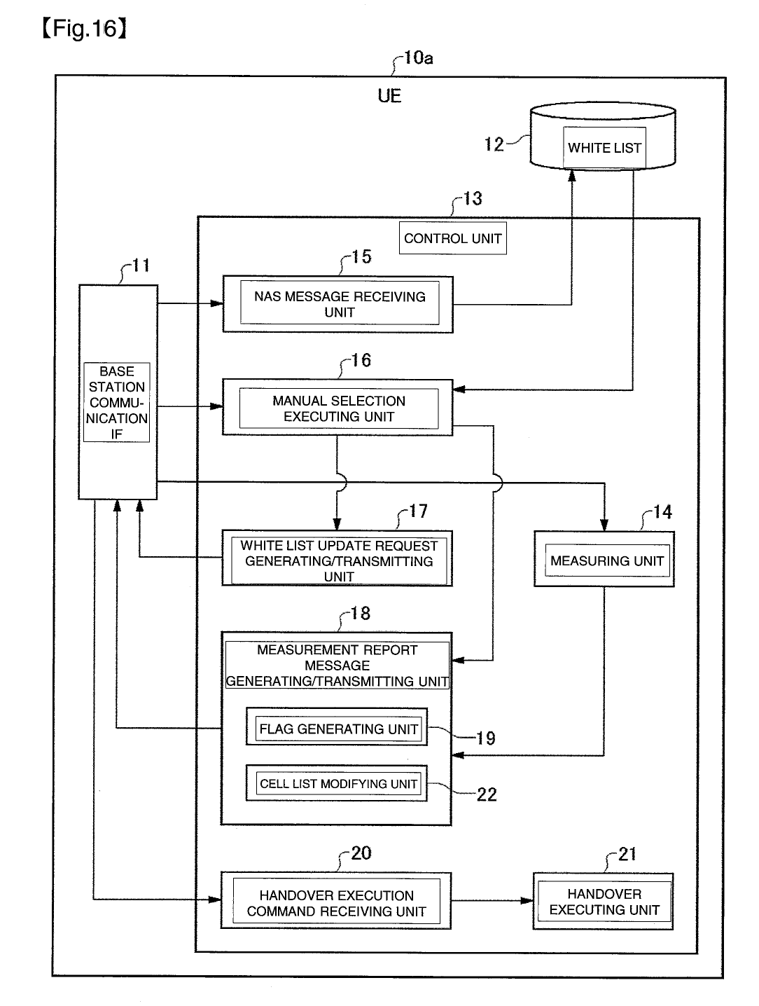

FIG. 16 is a diagram showing a configuration of a UE 10a of the fourth embodiment. The configurations of the source HeNB, the HeNB gateway and the MME in the fourth embodiment are similar to the third embodiment.

A basic configuration of the UE 10a of the fourth embodiment is the same as the UE 10 of the first to third embodiments. However, the UE 10a of the fourth embodiment is different in that the measurement report message generating/transmitting unit 18 has a cell list modifying unit 22. Usually, in a cell list included in the Measurement report message, the cells are sorted in descending order of the reception quality. However, the cell list modifying unit 22 modifies the order of the cell list so that the CSG cell selected through the manual selection is positioned at beginning of the cell list.

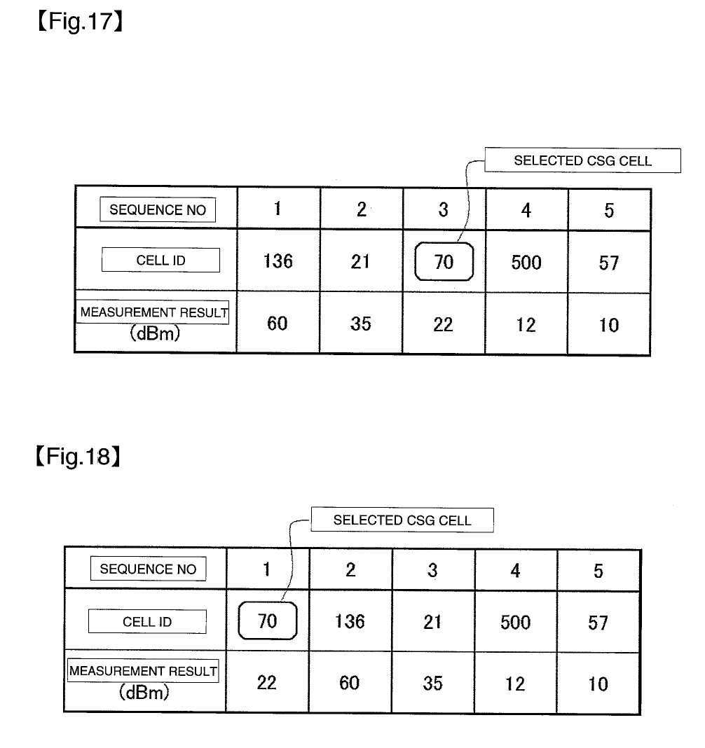

FIG. 17 is a diagram showing a configuration of the Measurement report message before the cell list is modified by the cell list modifying unit 22, and FIG. 18 is a diagram showing the configuration of the Measurement report message after the modification. As shown in FIG. 17, in the cell list, Sequence Nos are assigned to the cells in descending order of the measurement result, and the cells are sorted. As shown in FIG. 18, the cell list modifying unit 22 modifies the cell list so that the cell ID of the CSG cell selected through the manual selection (in this example, “70”) is positioned at the beginning.

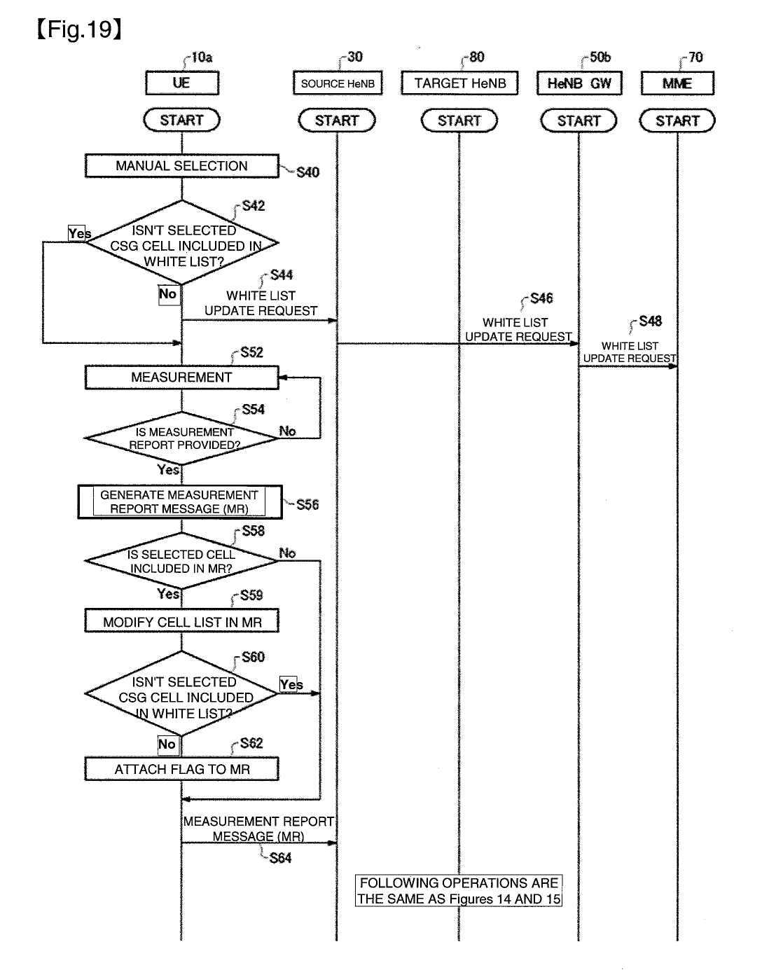

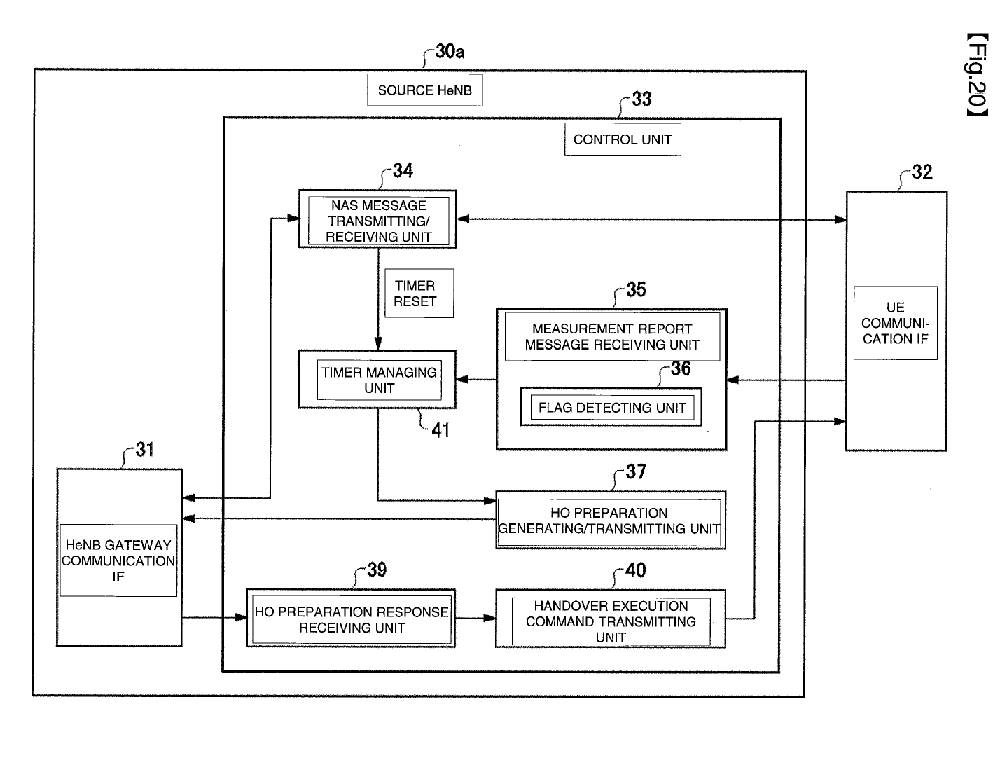

FIG. 19 is a diagram showing the operations for the handover by the wireless communication system of the fourth embodiment. The basic operations for the handover of the fourth embodiment are the same as the operations for the handover of the third embodiment. In the fourth embodiment, if the CSG cell selected in the manual selection is included in the cell list in the Measurement report message (Yes in S58), there is a process for modifying the cell list in the Measurement report message so that the selected CSG cell is positioned at the beginning (S59). Hereinabove, the configuration and the operations of the wireless communication system of the fourth embodiment have been described.

In the wireless communication system of the fourth embodiment, the CSG cell selected in the manual selection is positioned at the beginning of the cell list in the Measurement report message so that the selected CSG cell appears to have the best reception quality. Thereby, in the present embodiment, the manually selected CSG cell is set as the candidate for the target cell in the HO preparation to be transmitted to the HeNB gateway 50 by the source HeNB 30, and thereby, the handover to the selected CSG cell is enabled.

It should be noted that, in the present embodiment, an example has been described in which the cell list is modified so that the selected CSG cell is positioned at the beginning of the cell list. However, the reception quality of the selected CSG cell can also be caused to appear as the best by attaching an offset only to the CSG cell selected when the UE performs the measurement.

### Fifth Embodiment

Next, the wireless communication system of a fifth embodiment will be described. In the above described embodiments, the HeNB gateway 50 has controlled a timing of performing the Admission Control process. However, the present embodiment controls a timing of transmitting the HO preparation from a source HeNB 30a, and thereby prevents the inconvenience that the handover to the selected CSG cell is judged to be impossible because the Admission Control process is performed before the addition to the white list is completed.

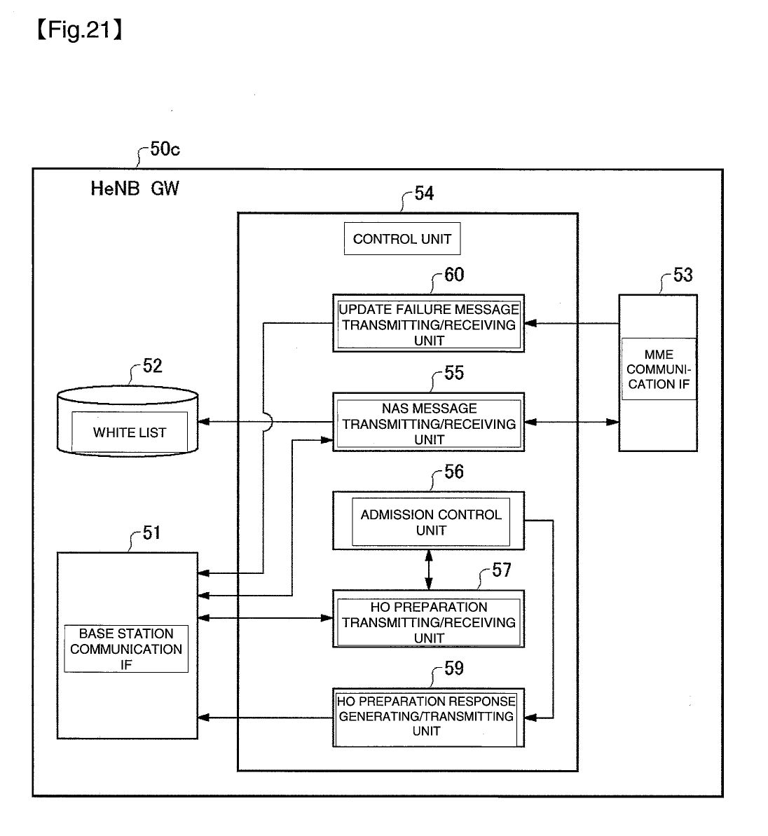

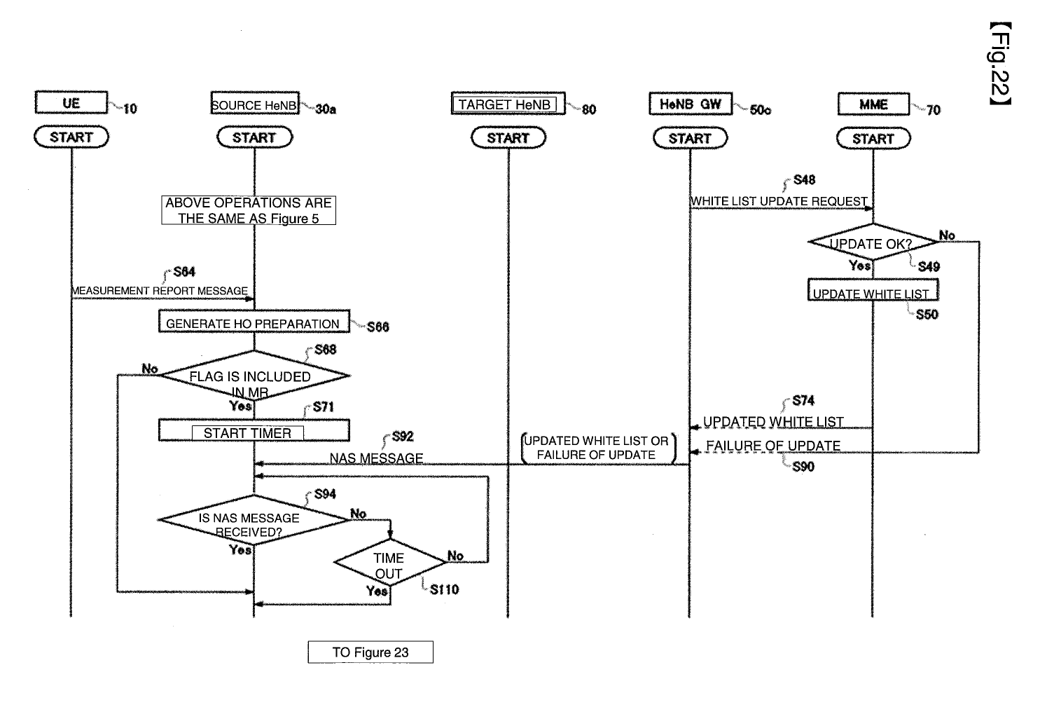

FIG. 20 is a diagram showing a configuration of the source HeNB 30a of the fifth embodiment. The configurations of the UE and the MME in the fifth embodiment are similar to the third embodiment. As shown in FIG. 21, in a configuration of an HeNB gateway 50c, a flag detection function is removed from the handover preparation transmitting/receiving unit 57 of FIG. 10, and the notifications from the update failure message transmitting/receiving unit 60 and the NAS message transmitting/receiving unit 55 to the Admission Control unit 56 are omitted.

A basic configuration of the source HeNB 30a of the fifth embodiment is the same as the source HeNB 30 of the first to fourth embodiments. However, the source HeNB 30a of the fifth embodiment is different in that the source HeNB 30a of the fifth embodiment has a timer managing unit 41, in addition to the configuration of the source HeNB 30 of the first embodiment. Moreover, the source HeNB 30a of the fifth embodiment is different in that the HO preparation generating/transmitting unit 37 is not provided with the flag generating unit.

If the measurement report message receiving unit 35 has received the Measurement report message including the white list update flag, the timer managing unit 41 starts a timer, and measures a time elapsed since the reception of the Measurement report message. If the NAS message transmitting/receiving unit 34 has received the updated white list, the timer managing unit 41 resets the timer. If the timer has been reset, or if the timer has exceeded a predetermined set time, the timer managing unit 41 notifies the HO preparation generating/transmitting unit 37 that the timer has been reset, or that the timer has exceeded the predetermined set time. In response to the notification from the timer managing unit 41, the HO preparation generating/transmitting unit 37 transmits the HO preparation to the HeNB gateway 50.

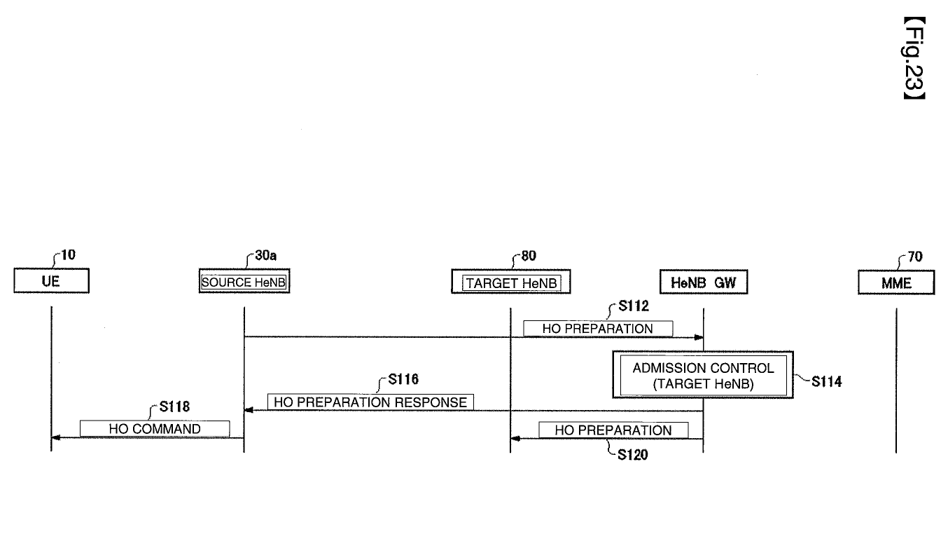

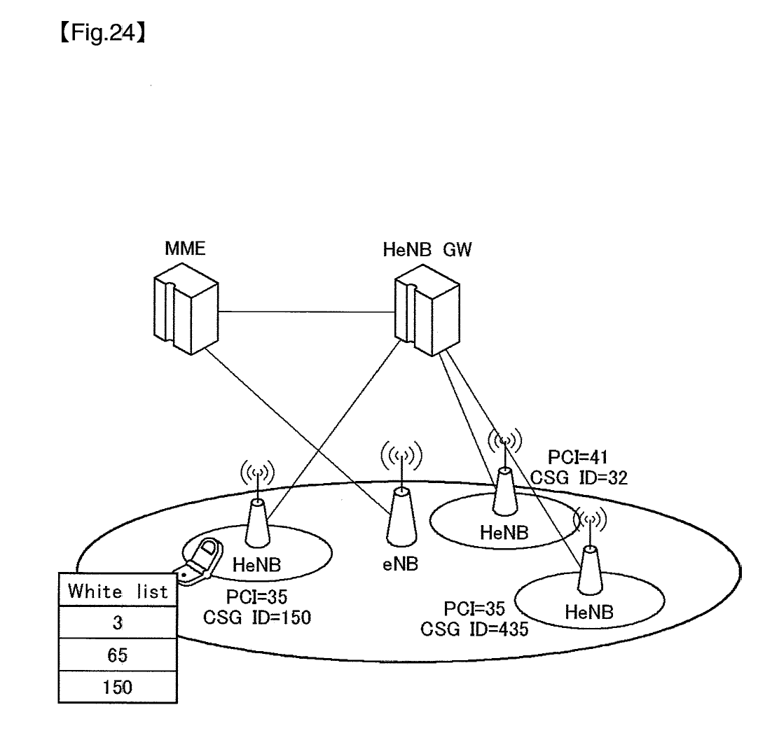

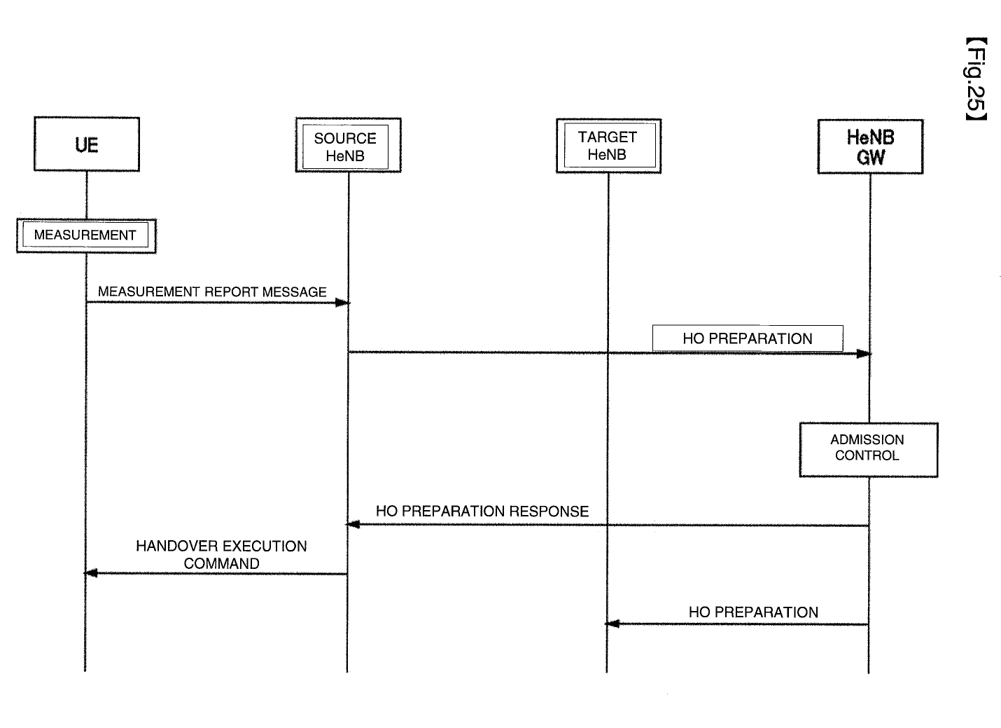

FIGS. 22 and 23 are diagrams describing the operations for the handover by the wireless communication system of the fifth embodiment. In the fifth embodiment, the operations until the Measurement report message is received from the UE 10 and the HO preparation is generated (S66) are the same as the first embodiment.

The source HeNB 30 determines whether or not the Measurement report message includes the flag indicating that the white list is being updated (S68). If the Measurement report message includes the flag (Yes in S68), the timer managing unit 41 in the source HeNB 30 starts the timer (S71).

The source HeNB 30 determines whether or not the NAS message indicating the updated white list or the failure of the update has been received from the HeNB (S94). As a result of this determination, if the NAS message has not been received (No in S94), the source HeNB 30 determines whether or not the timer has timed out (S110). If the timer has not timed out (No in S110), the source HeNB 30 determines again whether or not the NAS message has been received (S94). In other words, the source HeNB 30 repeatedly determines whether or not the NAS message has been received, until the timer times out. If the timer has timed out (Yes in S110), or if the NAS message has been received (Yes in S94), the source HeNB 30 transmits the HO preparation to the HeNB gateway 50. Hereinabove, the configuration and the operations of the wireless communication system of the fifth embodiment have been described.

The fifth embodiment retards the timing of transmitting the HO preparation from the source HeNB 30 to the HeNB gateway 50, and thereby prevents the inconvenience that the handover to the CSG cell selected through the manual selection is determined to be impossible because the Admission Control process is performed before the addition to the white list is completed, and realizes the appropriate handover.

In the fifth embodiment, it is not necessary to attach the flag indicating that the white list is being updated, to the HO preparation, and moreover, a conventional configuration of the HeNB gateway can also be used.

Hereinabove, the wireless communication system and the handover method of the present invention have been described in detail with the embodiments. However, the present invention is not limited to the above described embodiments.

In the above described fourth embodiment, an example has been described in which the selected CSG cell is positioned at the beginning of the cell list in the Measurement report message so that the HeNB gateway can identify the selected CSG cell. However, the HeNB gateway may compare the white list before being updated with the updated white list to extract an updated CSG cell, and thereby obtain the manually selected CSG cell.

Preferred embodiments of the present invention which are currently conceivable have been described above. However, various variations can be made to the present embodiments, and all such variations within the true spirit and scope of the present invention are intended to be comprised in the appended claims.

### INDUSTRIAL APPLICABILITY

The present invention has an excellent advantageous effect that the handover destination can be appropriately selected by using the white list in which a result of the manual selection is reflected, even if a request for manually updating the white list and the Measurement report message contend with each other, and the present invention is useful as the wireless communication system or the like which performs the handover to the CSG cell.

### REFERENCE SIGNS LIST

10, 10a UE
11 base station communication IF
12 white list storing unit
13 control unit
14 measuring unit
15 NAS message receiving unit
16 manual selection executing unit
17 white list update request generating/transmitting unit
18 measurement report message generating/transmitting unit
19 flag generating unit
20 handover execution command receiving unit
21 handover executing unit
22 cell list modifying unit
30, 30a source HeNB
31 HeNB gateway communication IF
32 UE communication IF
33 control unit
34 NAS message transmitting/receiving unit
35 measurement report message receiving unit
36 flag detecting unit
37 HO preparation generating/transmitting unit
38 flag generating unit
39 HO preparation response receiving unit
40 handover execution command transmitting unit
41 timer managing unit
50, 50a, 50b HeNB gateway
51 base station communication IF
52 white list storing unit
53 MME communication IF
54 control unit
55 NAS message transmitting/receiving unit
56 Admission Control unit
57 HO preparation transmitting/receiving unit
58 flag detecting unit
59 HO preparation response generating/transmitting unit
60 update failure message transmitting/receiving unit
61 timer managing unit
70 Mobility Management Entity (MME)
71 HeNB gateway communication IF
72 white list storing unit
73 control unit
74 NAS message transmitting/receiving unit
75 white list updating unit
76 update failure message transmitting unit

1. A terminal device used in a wireless communication network comprising a Mobility Management Entity which generates a white list in which CSG (Closed Subscriber Group) cells being accessible by the terminal device are enumerated, and a HeNB gateway which decides based on the white list whether or not access is possible, the terminal device comprising:
a white list storing unit which has stored the white list;
a manual selection executing unit which accepts manual selection of a CSG cell, and if the selected CSG cell has not been stored in the white list storing unit, requests the Mobility Management Entity to add the CSG cell to the white list;
a measurement report message generating unit which measures radio wave reception quality of neighboring CSG cells and generates a Measurement report message, the measurement report message generating unit generating the Measurement report message attached with information indicating that the white list is being updated, if the CSG cell which has been accepted by manual selection is comprised in CSG cells to be included in the Measurement report message, and the selected CSG cell has not been stored in the white list storing unit; and
a measurement report message transmitting unit which transmits the Measurement report message to a home base station of the CSG cell.

2. The terminal device according to claim 1, wherein the measurement report message generating unit generates the Measurement report message including a cell list in which the CSG cells are sorted in descending order of the reception quality, and
the measurement report message generating unit comprises a cell list modifying unit which modifies the order of the cell list so that the selected CSG cell is arranged at beginning.

3. A home base station of a CSG cell, the home base station being used in a wireless communication network comprising a Mobility Management Entity which generates a white list in which CSG cells being accessible by a terminal device are enumerated, and a HeNB gateway which decides based on the white list whether or not access is possible, the home base station comprising:
a measurement report message receiving unit which receives a Measurement report message transmitted from the terminal device;
a detecting unit which detects whether or not information indicating that the white list is being updated is included in the Measurement report message;
a generating unit which generates a Handover preparation message in response to the Measurement report message, the generating unit generating the Handover preparation message including the information indicating that the white list is being updated, when the information indicating that the white list is being updated has been detected; and
a transmitting unit which transmits the Handover preparation message to the HeNB gateway.

4. A home base station of a CSG cell, the home base station being used in a wireless communication network comprising a Mobility Management Entity which generates a white list in which CSG cells being accessible by a terminal device are enumerated, and a HeNB gateway which decides based on the white list whether or not access is possible, the home base station comprising:
a measurement report message receiving unit which receives a Measurement report message transmitted from the terminal device;
a detecting unit which detects whether or not information indicating that the white list is being updated is included in the Measurement report message;
a generating unit which generates a Handover preparation message in response to the Measurement report message; and
a transmitting unit which transmits the Handover preparation message to the HeNB gateway, the transmitting unit waiting for reception of a white list update response from the HeNB gateway and then transmitting the Handover preparation message, when the information indicating that the white list is being updated has been detected.

5. The home base station according to claim 4, wherein when a predetermined time has elapsed since the Measurement report message has been received, even if the white list update response has not been received, the transmitting unit transmits the Handover preparation message.

6. A home base station of a CSG cell, the home base station being used in a wireless communication network comprising a Mobility Management Entity which generates a white list in which CSG cells being accessible by a terminal device are enumerated, and a HeNB gateway which decides based on the white list whether or not access is possible, the home base station comprising:
a measurement report message receiving unit which receives a Measurement report message transmitted from the terminal device;
a detecting unit which detects whether or not information indicating that the white list is being updated is included in the Measurement report message;
a generating unit which generates a Handover preparation message in response to the Measurement report message; and
a transmitting unit which transmits the Handover preparation message to the HeNB gateway, the transmitting unit transmitting the Handover preparation message after a predetermined time has elapsed since the Measurement report message has been received, when the information indicating that the white list is being updated has been detected.

7-17. (canceled)
